(19) United States
(12) Patent Application Publication
(10) Pub. No.: US 2013/0004653 A1
(43) Pub. Date: Jan. 3, 2013

(54) Alignment Film Coating Method and Alignment Film Coating Apparatus

(75) Inventors: Hsiang-Yin Shih, Shenzhen City (CN); Cheng-Chuan Chan, Shenzhen City (CN); Bing-Jei Liao, Shenzhen City (CN)

(73) Assignee: Shenzhen China Star Optoelectronics Technology Co.,Ltd., Shenzhen City, Guangdong (CN)

(21) Appl. No.: 13/379,636

(22) PCT Filed: Jul. 18, 2011
(86) PCT No.: PCT/CN2011/077280

§ 371 Date: Dec. 20, 2011

(30) Foreign Application Priority Data
Jun. 30, 2011 (CN) 201110182222.6

(51) Int. Cl. B05D 5/06; B05B 15/06; B05B 15/00; B05B 1/00; B05D 1/02

(52) U.S. Cl. 427/9; 427/162; 118/300; 118/712; 118/320

(57) ABSTRACT

An alignment film coating method for spraying alignment film droplets on a glass substrate provided with color filters is disclosed. The color filters include a plurality of groups of cuboidal R, G, B trichromatic color filters having an equal area but different thicknesses and arranged in rows and columns, and the R, G, B trichromatic color filters are disposed at intervals with a groove being formed between every two adjacent color filters. A plurality of spray nozzles for spraying the alignment film droplets are arranged in a direction parallel to an arrangement direction of the color filters of a same color. An alignment film coating apparatus is further disclosed. By using the alignment film coating method and the alignment film coating apparatus of the present disclosure to coat an alignment film, the alignment film can be made more uniform and flat.

### FIELD OF THE INVENTION

The present disclosure generally relates to the technical field of liquid crystal displays (LCDs), and more particularly, to an alignment film coating method and an alignment film coating apparatus for a color filter in an LCD.

### BACKGROUND OF THE INVENTION

Coating of alignment films for high-generation liquid crystal panels is accomplished through ink spraying. Specifically, alignment film droplets at both a high speed and a high density are dripped on a surface of a thin film transistor (TFT) substrate or a color filter (CF) substrate, and then the alignment film droplets diffuse under the action of the surface tension to form a flat alignment film surface. An effect of the ink-spraying coating is affected by vias in a TFT indium tin oxide (ITO) layer and thickness differences between color filters in the CF substrate, which causes alignment film droplets of a same size to form nonuniform film surfaces respectively.

Referring to FIGS. 1 and 2 together, a CF substrate 100 comprises a glass substrate 110, and a black matrix 120 and a plurality of groups of cuboidal R, G, B trichromatic color filters 130 having an equal area but different thicknesses are disposed in rows and columns on the glass substrate 110. Here, only one group of color filters 130 is shown.

Referring to FIG. 3, during a process of coating an alignment film on a CF substrate 100 in the prior art, a spray head 140 comprising a plurality of spray nozzles 150 moves in a direction indicated by an arrow shown in this figure. Because thicknesses of the R, G, B trichromatic color filters 130 are different, the coating effect is affected by the thickness differences therebetween; i.e., when an alignment film droplet is dripped between two color filters 130 having a thickness difference therebetween, it is impossible for the alignment film droplet to flatly diffuse to surfaces of the two color filters 130. This makes the alignment film formed on the surfaces of the color filters 130 nonuniform in thickness and uneven.

Currently, this problem is solved by spraying large droplets, adopting a slower moving speed of the spray head 140 or reducing distances between the spray nozzles 150 to increase the density of droplets, but nonuniform diffusion still occurs due to viscosity of the alignment film droplets, and furthermore, these solutions also consume more labor hours.

### SUMMARY OF THE INVENTION

An objective of the present disclosure is to solve the problem of nonuniform and uneven coating of alignment films in the prior art by providing an alignment film coating method and an alignment film coating apparatus.

To achieve this objective, an embodiment of the present disclosure provides an alignment film coating method for spraying alignment film droplets on a glass substrate provided with color filters. The color filters include a plurality of groups of cuboidal R, G, B trichromatic color filters having an equal area but different thicknesses and arranged in rows and columns, and the R, G, B trichromatic color filters are disposed at intervals with a groove being formed between every two adjacent color filters. A plurality of spray nozzles for spraying the alignment film droplets are arranged in a direction parallel to an arrangement direction of the color filters of a same color. The plurality of spray nozzles are translated orthogonally to the arrangement direction of the color filters of a same color to spray the alignment film droplets so that the alignment film droplets dripped diffuse naturally without being impeded by the thickness differences.

According to a preferred embodiment of the present disclosure, a spraying amount of the alignment film droplets sprayed on each of the color filters is controlled according to the thickness differences between the R, G, B trichromatic color filters.

According to a preferred embodiment of the present disclosure, thicknesses of the R, G, B trichromatic color filters are measured in real time when the alignment film droplets are sprayed on the color filters so as to control the spraying amount correspondingly.

According to a preferred embodiment of the present disclosure, the spraying amount is controlled according to the number of the alignment film droplets dripped.

According to a preferred embodiment of the present disclosure, the spraying amount is controlled according to a dripping time of the alignment film droplets.

According to a preferred embodiment of the present disclosure, the alignment film coating method further comprises rotating the glass substrate to render the alignment film droplets uniform and flat.

To achieve the aforesaid objective, another embodiment of the present disclosure provides an alignment film coating apparatus for spraying alignment film droplets on a glass substrate provided with color filters. The color filters include a plurality of groups of cuboidal R, G, B trichromatic color filters having an equal area but different thicknesses and arranged in rows and columns, and the R, G, B trichromatic color filters are disposed at intervals with a groove being formed between every two adjacent color filters. The alignment film coating apparatus comprises a base and a spray head. The base is adapted to place the glass substrate thereon. The spray head comprises a plurality of spray nozzles arranged in a direction parallel to an arrangement direction of the color filters of a same color. The plurality of spray nozzles are translated orthogonally to the arrangement direction of the color filters of a same color to spray the alignment film droplets so that the alignment film droplets dripped diffuse naturally without being impeded by the thickness differences.

According to a preferred embodiment of the present disclosure, the alignment film coating apparatus further comprises a sensor disposed on the spray head, and the sensor is configured to measure thicknesses of the R, G, B trichromatic color filters in real time so as to control the spraying amount of the spray head correspondingly.

According to a preferred embodiment of the present disclosure, the spraying amount is controlled by the spray head according to the number of or a dripping time of the alignment film droplets dripped, or is controlled by the base according to a moving speed.

According to a preferred embodiment of the present disclosure, the base is further adapted to rotate to render the alignment film droplets uniform and flat.

To achieve the aforesaid objective, a further embodiment of the present disclosure provides an alignment film coating method for spraying alignment film droplets on a color filter substrate. The color filter substrate comprises a glass substrate, a black matrix disposed on the glass substrate and color filters disposed within the black matrix. The color filters include a plurality of groups of cuboidal R, G, B trichromatic color filters having an equal area but different thicknesses and arranged in rows and columns. A plurality of spray nozzles for spraying the alignment film droplets are translated in parallel to an arrangement direction of the color filters of a same color so that the alignment film droplets dripped diffuse naturally without being impeded by the thickness differences.

The embodiments of the present disclosure have the following benefits: as compared to the prior art, the alignment film coating method and the alignment film coating apparatus of the present disclosure can make alignment films more uniform and flat.

### BRIEF DESCRIPTION OF THE DRAWINGS

FIG. 1 is a schematic cross-sectional view of a prior art color filter (CF) substrate.

FIG. 2 is a top view of the CF substrate shown in FIG. 1.

FIG. 3 is a schematic view illustrating an alignment film coating method in the prior art.

FIG. 4 is a schematic cross-sectional view of a CF substrate according to the present disclosure.

FIG. 5 is a schematic view illustrating an alignment film coating method according to a preferred embodiment of the present disclosure.

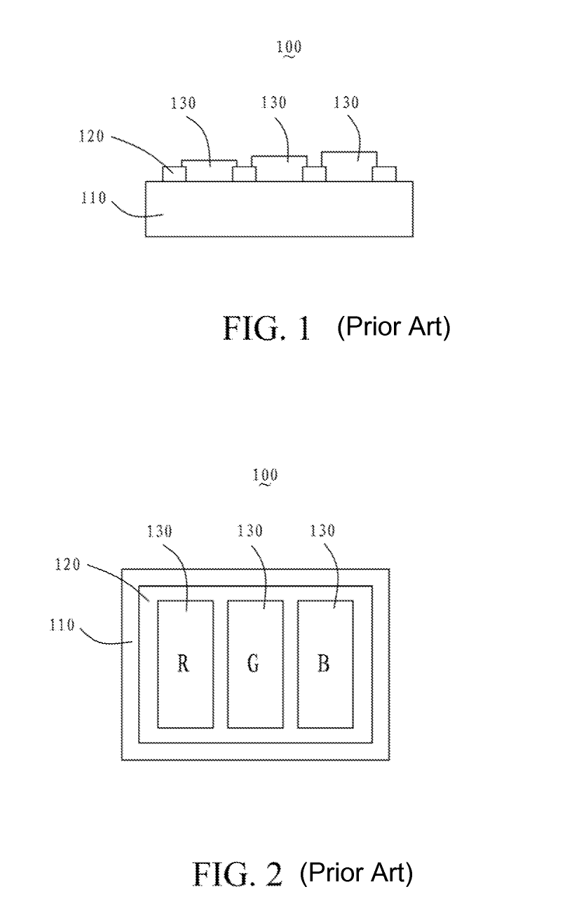

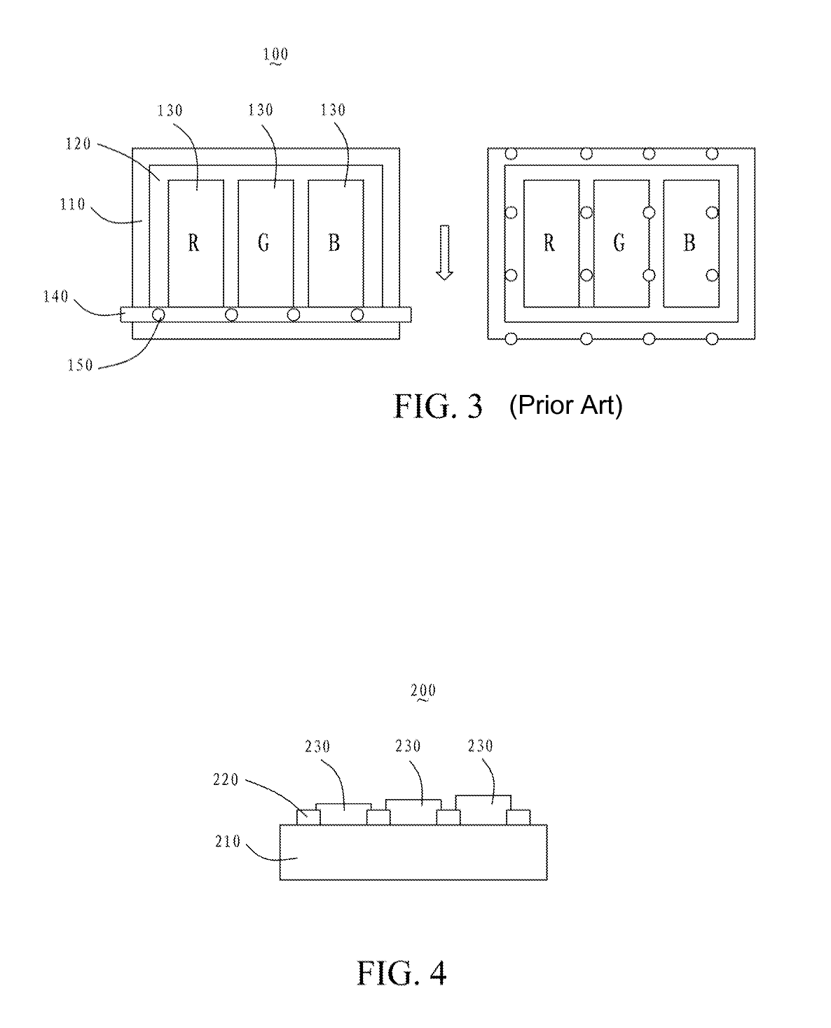

### DETAILED DESCRIPTION OF THE INVENTION

The present disclosure is more particularly described in the following examples that are intended as illustrative only since numerous modifications and variations therein will be apparent to those skilled in the art.

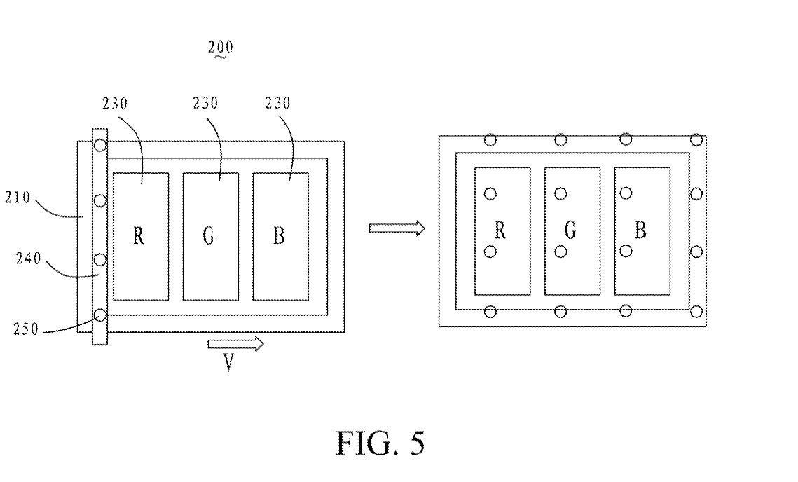

Referring to FIGS. 4 and 5 together, FIG. 4 is a schematic cross-sectional view of a CF substrate 200 according to the present disclosure. An embodiment of the present disclosure provides an alignment film coating method for spraying alignment film droplets on a glass substrate 210 provided with color filters and a black matrix 220. As shown in FIG. 4, the color filter comprises a plurality of groups of cuboidal R, G, B trichromatic color filters 230 having an equal area but different thicknesses and arranged in rows and columns, and the R, G, B trichromatic color filters 230 are disposed at intervals with a groove being formed between every two adjacent color filters 230. A spray head 240 comprises a plurality of spray nozzles 250 for spraying the alignment film droplets, and the plurality of spray nozzles 250 are arranged in a direction parallel to an arrangement direction of the color filters 230 of a same color. The plurality of spray nozzles 250 are translated orthogonally to the arrangement direction (i.e., the direction indicated by an arrow V in FIG. 4) of the color filters 230 of a same color to spray the alignment film droplets so that the alignment film droplets dripped diffuse naturally without being impeded by thickness differences. Specifically, one R color filter, one G color filter and one B color filter are viewed as one unit, and a plurality of such units are arranged in the direction of the arrow V and the direction orthogonal to the arrow V. Color filters 230 of a same color are arranged in sequence in the direction orthogonal to the arrow V; for example, color filters of the red color (R) are arranged in a column in the direction orthogonal to the arrow V, color filters of the green color (G) are arranged in a column in the direction orthogonal to the arrow V, and color filters of the blue color (B) are arranged in a column in the direction orthogonal to the arrow V. Hence, the arrangement direction of color filters of a same color refers to the direction of the arrow V herein. This method further comprises the following steps:

controlling a spraying amount of the alignment film droplets sprayed on each of the color filters 230 according to the thickness differences of the R, G, B trichromatic color filters 230;

measuring thicknesses of the R, G, B trichromatic color filters 230 in real time when the alignment film droplets are sprayed on the color filters 230 so as to control the spraying amount correspondingly, and specifically, the spraying amount may be controlled according to the number of the alignment film droplets dripped or according to a dripping time of the alignment film droplets; and

then, rotating the glass substrate 210 to render the alignment film droplets uniform and flat.

Another embodiment of the present disclosure further provides an alignment film coating apparatus, which comprises a base (not shown) and a spray head 240. The base is adapted to place the glass substrate 210 thereon. The spray head 240 comprises a plurality of spray nozzles 250 arranged in a direction parallel to the arrangement direction of color filters 230 of a same color. The plurality of spray nozzles 250 are translated orthogonally to the arrangement direction of the color filters 230 of a same color to spray the alignment film droplets so that the alignment film droplets diffuse naturally without being impeded by thickness differences. Additionally, the alignment film coating apparatus further comprises a sensor configured to measure thicknesses of the R, G, B trichromatic color filters 230 in real time so as to control the spraying amount of the spray head correspondingly. In a preferred embodiment, the sensor is disposed on the spray head.

In an embodiment, the spraying amount is controlled by the spray head 240 according to the number of or a dripping time of alignment film droplets dripped or by the base according to a moving speed.

Then, the base is further rotated to render the alignment film droplets uniform and flat.

From the above descriptions, it can be readily appreciated by those skilled in the art that, by using the alignment film coating method and the alignment film coating apparatus of the present disclosure to coat an alignment film, the alignment film can be made more uniform and flat.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An alignment film coating method for spraying alignment film droplets on a glass substrate provided with color filters, wherein the color filters include a plurality of groups of cuboidal R, G, B trichromatic color filters having an equal area but different thicknesses and arranged in rows and columns, and the R, G, B trichromatic color filters are disposed at intervals with a groove being formed between every two adjacent color filters, and wherein a plurality of spray nozzles for spraying the alignment film droplets are arranged in a direction parallel to an arrangement direction of the color filters of a same color, and the plurality of spray nozzles are translated orthogonally to the arrangement direction of the color filters of a same color to spray the alignment film droplets so that the alignment film droplets dripped diffuse naturally without being impeded by the thickness differences.

2. The alignment film coating method of claim 1, wherein a spraying amount of the alignment film droplets sprayed on each of the color filters is controlled according to the thickness differences between the R, G, B trichromatic color filters.

3. The alignment film coating method of claim 2, wherein thicknesses of the R, G, B trichromatic color filters are measured in real time when the alignment film droplets are sprayed on the color filters so as to control the spraying amount correspondingly.

4. The alignment film coating method of claim 3, wherein the spraying amount is controlled according to the number of the alignment film droplets dripped.

5. The alignment film coating method of claim 3, wherein the spraying amount is controlled according to a dripping time of the alignment film droplets.

6. The alignment film coating method of claim 1, further comprising rotating the glass substrate to render the alignment film droplets uniform and flat.

7. An alignment film coating apparatus for spraying alignment film droplets on a glass substrate provided with color filters, wherein the color filters include a plurality of groups of cuboidal R, G, B trichromatic color filters having an equal area but different thicknesses and arranged in rows and columns, and the R, G, B trichromatic color filters are disposed at intervals with a groove being formed between every two adjacent color filters, and wherein the alignment film coating apparatus comprises a base and a spray head, the base is adapted to place the glass substrate thereon, the spray head comprises a plurality of spray nozzles arranged in a direction parallel to an arrangement direction of the color filters of a same color, and the plurality of spray nozzles are translated orthogonally to the arrangement direction of the color filters of a same color to spray the alignment film droplets so that the alignment film droplets dripped diffuse naturally without being impeded by the thickness differences.

8. The alignment film coating apparatus of claim 7, further comprising a sensor disposed on the spray head, wherein the sensor is configured to measure thicknesses of the R, G, B trichromatic color filters in real time so as to control the spraying amount of the spray head correspondingly.

9. The alignment film coating apparatus of claim 8, wherein the spraying amount is controlled by the spray head according to the number of or a dripping time of the alignment film droplets dripped, or is controlled by the base according to a moving speed.

10. The alignment film coating apparatus of claim 7, wherein the base is further adapted to rotate to render the alignment film droplets uniform and flat.

11. An alignment film coating method for spraying alignment film droplets on a color filter substrate, wherein the color filter substrate comprises a glass substrate, a black matrix disposed on the glass substrate and color filters disposed within the black matrix, and the color filters include a plurality of groups of cuboidal R, G, B trichromatic color filters having an equal area but different thicknesses and arranged in rows and columns, and wherein a plurality of spray nozzles for spraying the alignment film droplets are translated in parallel to an arrangement direction of the color filters of a same color so that the alignment film droplets dripped diffuse naturally without being impeded by the thickness differences.

12. The alignment film coating method of claim 11, wherein a spraying amount of the alignment film droplets sprayed on each of the color filters is controlled according to the thickness differences between the R, G, B trichromatic color filters.

13. The alignment film coating method of claim 12, wherein thicknesses of the R, G, B trichromatic color filters are measured in real time when the alignment film droplets are sprayed on the color filters so as to control the spraying amount correspondingly.

14. The alignment film coating method of claim 13, wherein the spraying amount is controlled according to the number of the alignment film droplets dripped.

15. The alignment film coating method of claim 13, wherein the spraying amount is controlled according to a dripping time of the alignment film droplets.

16. The alignment film coating method of claim 11, further comprising rotating the glass substrate to render the alignment film droplets uniform and flat.
